(19) United States
(12) Patent Application Publication
(10) Pub. No.: US 2011/0300038 A1
(43) Pub. Date: Dec. 8, 2011

(54) Devices for Improving the Flatness of High-Density Microplates

(75) Inventors: Gary Lim, San Francisco, CA (US); Donald Sandell, San Jose, CA (US)

(73) Assignee: LIFE TECHNOLOGIES CORPORATION, Carlsbad, CA (US)

(21) Appl. No.: 13/092,781

(22) Filed: Apr. 22, 2011

Related U.S. Application Data
(63) Continuation of application No. 11/769,784, filed on Jun. 28, 2007, now abandoned.

(51) Int. Cl. B01L 99/00

(52) U.S. Cl. 422/569

(57) ABSTRACT

The present teachings are methods and apparatuses for improving the flatness of high density microwell plates. The flattening devices impart a level of flatness that is equal to or better than a predetermined value thereby enabling the microwells to be precisely located and easily accessed.

### CROSS-REFERENCE TO RELATED APPLICATIONS

This application is a continuation of U.S. patent application Ser. No. 11/769,784 filed Jun. 28, 2007, which is incorporated herein by reference.

### INTRODUCTION

The present teachings relate to improving the flatness of microwell plates. Methods and apparatuses that improve the flatness of microwell plates are disclosed.

### SUMMARY

Microwell plates are used on spotting or filling work stations wherein the microwells receive assays, reagents and/or samples. The plates may conform to SBS/ANSI (Society for Biomolecular Screening/American National Standards Institute) standard dimensions and may be about 127 millimeters in length by about 85 millimeters in width. The plate may include a large number of wells. For example, some plates may have 6,144 wells or more. The small size and compact spacing of the wells makes the precise alignment of the wells on a spotting or filling work station difficult. While the plate is typically manufactured to precise dimensions, the level of flatness can deviate from the nominal value to an extent that can lead to dispensed assays, reagents and/or samples missing their targeted wells. Thus, it would be advantageous to improve the level of flatness of the plates.

The present teachings provide methods and apparatuses that improve the flatness of the microwell plates. In some aspects of the present teachings, a rigid chuck is used to improve the flatness of the microwell plate by applying a vacuum to the plate and pulling the plate against the rigid chuck. In other aspects according to the present teachings, a pair of opposing channels that extend along a length of a rigid member are used to retain the microwell plate on the rigid member and to impart a level of flatness of at least a predetermined value. In other aspects according to the present teachings, a plurality of rigid framing members each having a channel therein are disposed along the edges of a microwell plate and impart a level of flatness of at least a predetermined value to the plate. In other aspects according to the present teachings, a method of flattening the microwell plate comprises securing the plate to a rigid member so the plate has a flatness of at least a predetermined value and maintaining the plate secured to the rigid member during a subsequent spotting or filling operation. These and other features of the present teachings are set forth herein.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a simplified view of a spotting or filling work station employing a flattening device according to the present teachings;

FIG. 2 is an exploded view of an embodiment of a flattening device according to the present teachings disposed between a microwell plate and an instrument deck;

FIG. 3A is a perspective view of the flattening device of FIG. 2;

FIG. 3B is an exploded view of the flattening device of FIG. 3A;

FIG. 4 is a bottom plan view of an alternate version of the flattening device of FIG. 2;

FIG. 5A is a top perspective view of another embodiment of a flattening device according to the present teachings which is incorporated into an instrument deck and shown having a microwell plate thereon;

FIG. 5B is a top plan view of the flattening device of FIG. 5A with the microwell plate thereon;

FIG. 5C is a top plan view of the flattening device of FIG. 5B with the microwell plate removed;

FIG. 5D is a cross-sectional view of the flattening device of FIG. 5C along line D-D;

FIG. 6A is a perspective view of yet another embodiment of a flattening device according to the present teachings showing a microwell plate being attached thereto;

FIG. 6B is a cross-sectional view of the flattening device of FIG. 6A along line B-B;

FIG. 7A is an exploded perspective view of still another embodiment of a flattening device according to the present teachings illustrated around a microwell plate;

FIG. 7B is a perspective view of a long framing member of the flattening device of FIG. 7A; and

FIG. 7C is a perspective view of a short framing member of the flattening device of FIG. 7A.

### DESCRIPTION OF VARIOUS EMBODIMENTS

The present teachings provide methods and apparatuses for improving the flatness of high density microwell plates. The following definitions and non-limiting guidelines must be considered in reviewing the description of the invention set forth herein.

The section headings used herein are used for organizational purposes only and are not to be construed as limiting the subject matter described in any way. Furthermore, while the present teachings are described in conjunction with various embodiments, it is not intended that the present teachings be limited to such embodiments. On the contrary, the present teachings encompass various alternatives, modifications and equivalents, as will be appreciated by those of skill in the art.

The description and specific examples, while indicating embodiments of the invention, are intended for purposes of illustration only and are not intended to limit the scope of the invention. Moreover, recitation of multiple embodiments having stated features is not intended to exclude other embodiments having additional features, or other embodiments incorporating different combinations of the stated features. Specific examples are provided for illustrative purposes of how to make, use and practice the devices and methods of this invention and, unless explicitly stated otherwise, are not intended to be a representation that given embodiments of this invention have, or have not, been made or tested.

As used herein, the word “include” and its variants are intended to be non-limiting, such that recitation of items in a list is not to the exclusion of other like items that may also be useful in the materials, compositions, devices and methods of this invention.

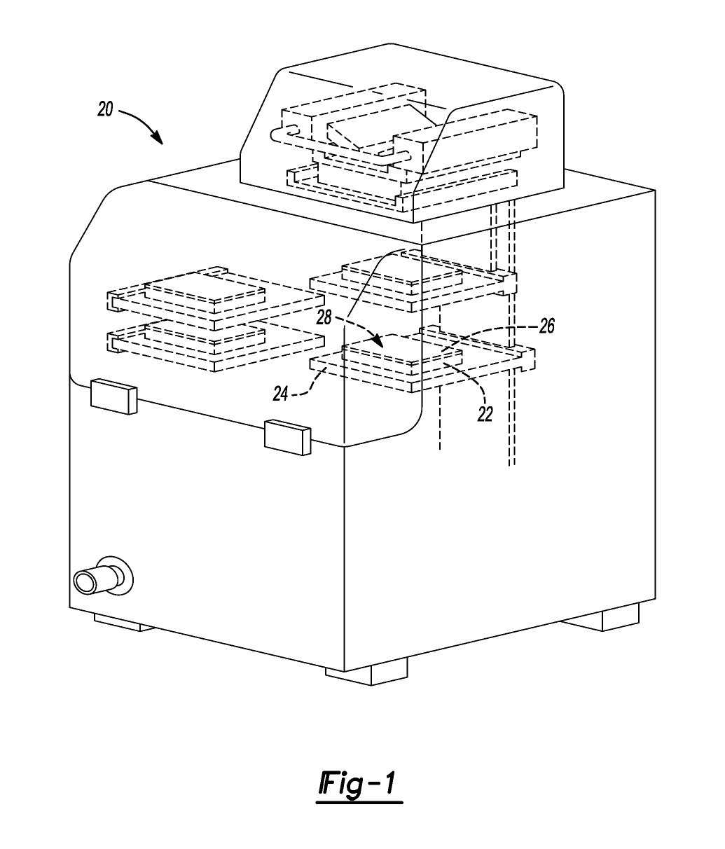

Referring to FIG. 1, a representative spotting or filling work station 20 employing a flattening device 22 according to the present teachings is shown. Flattening device 22 is attached to an instrument deck 24 of work station 20 and retains a microwell plate 26 thereon. Flattening device 22 is operable to impart a level of flatness to microwell plate 26 that is equal to or better than a predetermined value thereby enabling the microwells in plate 26 to be precisely located and easily accessed by work station 20. Flattening device 22 compensates for out-of-flat conditions of plate 26 which can lead to dispensed reagents and samples missing their targeted wells on plate 26. Thus, the use of flattening device 22 enables precise positioning of plate 26 relative to instrument deck 24 thereby facilitating the spotting and filling operations.

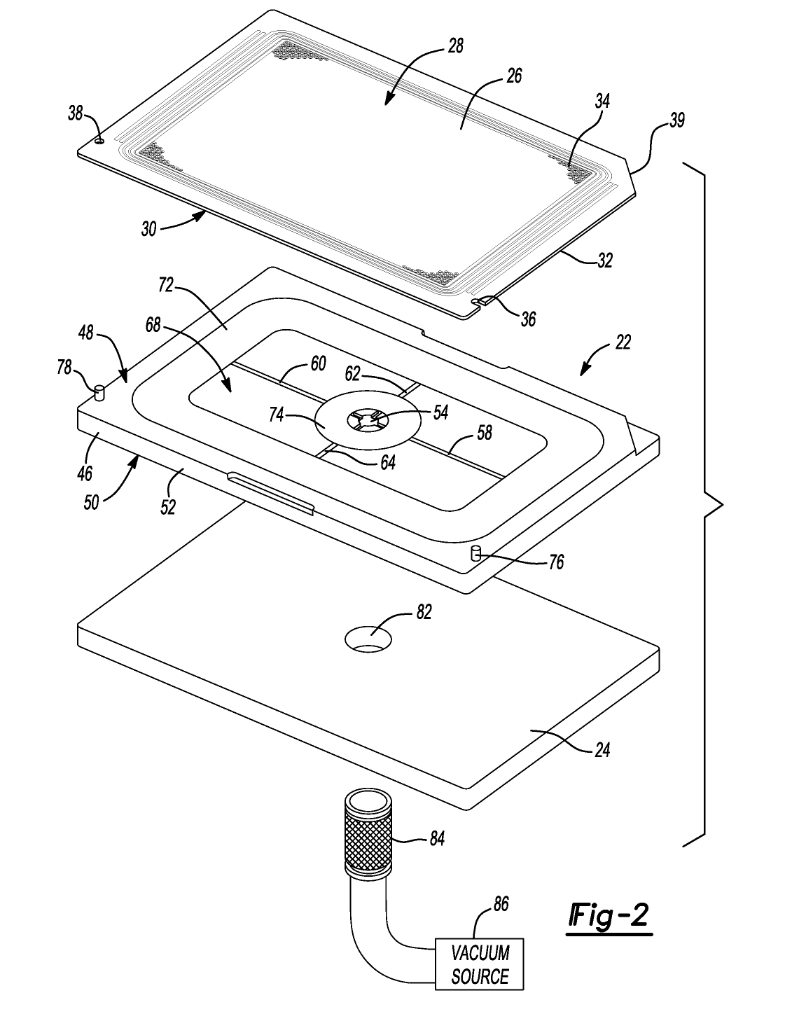

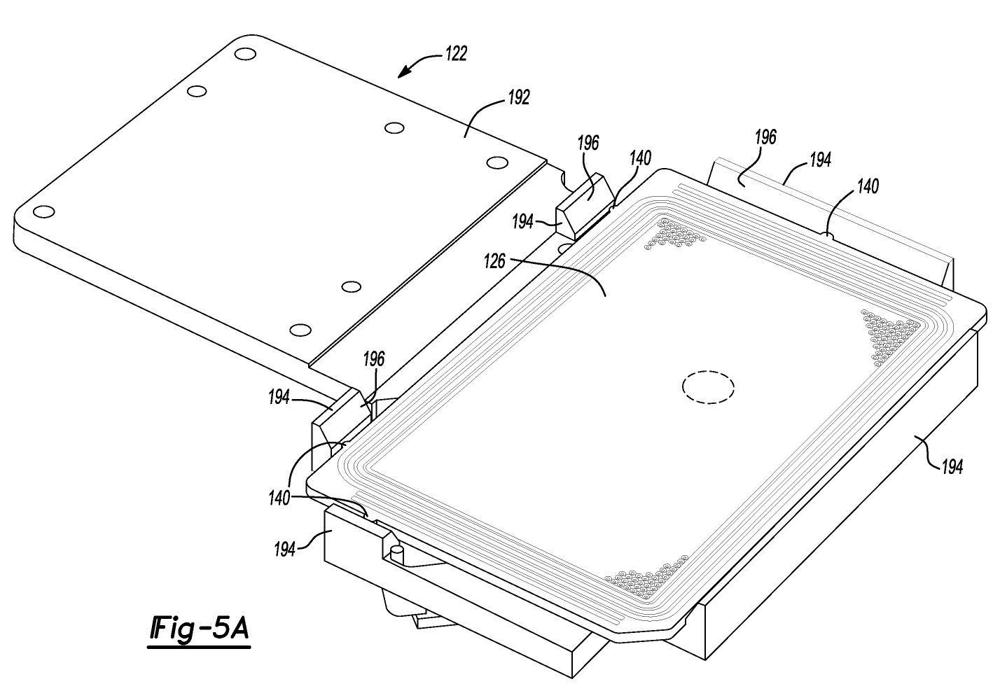

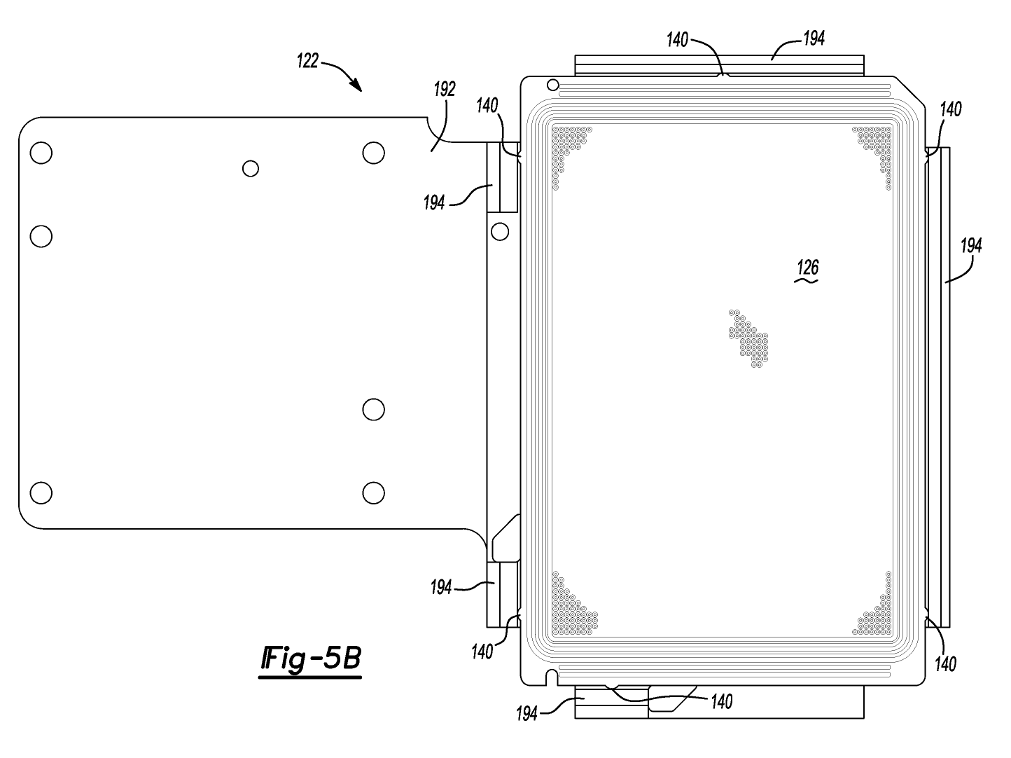

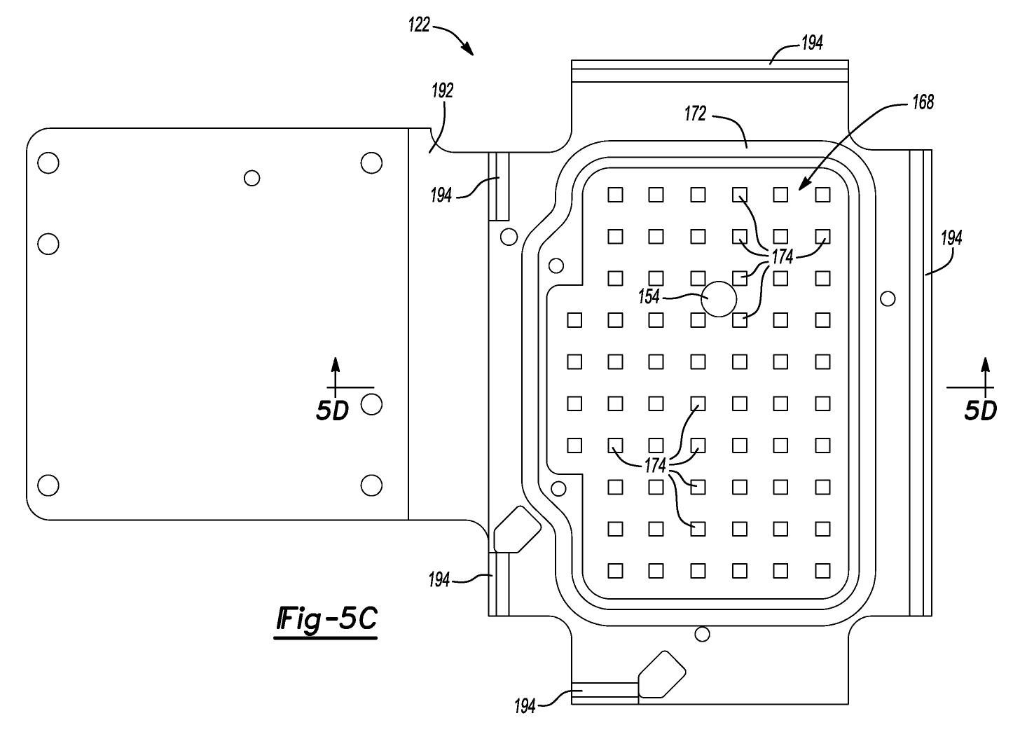

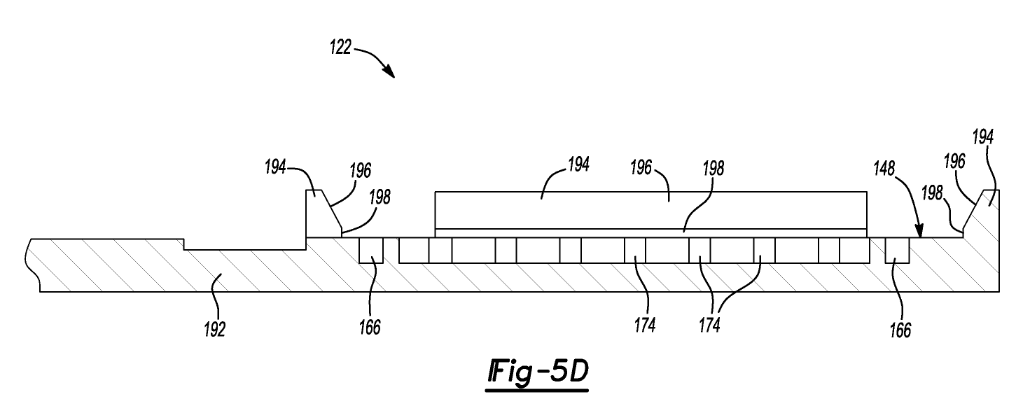

Plates 26, for which flattening device 22 is configured to retain, have opposite first and second surfaces 28, 30 and a sidewall 32 therebetween, as can be seen in FIG. 2. First surface 28 has a plurality of microwells 34 therein. Microwells 34 are configured to receive assays, reagents and/or samples by a spotting or filling work station 20. Second surface 30 of plate 26 is substantially planar and flat. Alignment features, in this case in the form of a slot 36 in sidewall 32 and an aperture 38 adjacent sidewall 32 are used to align plate 26 on flattening device 22, as described in more detail below. In some embodiments, such as that shown in FIG. 5B, a plurality of nubs or projections 140 that extend outwardly from sidewall 32 are used to align plate 26, as described in more detail below. It should be appreciated that alignment features other than those shown and/or discussed can be used with plate 26. For example, the beveled corner 39 on plate 26 may also be used as an alignment feature.

Plate 26 can be made from a plastic such as polypropylene with graphite filler. It should be appreciated, however, that other materials such as, but not limited to, glass, silica, plastics, thermal conductive materials, and any other material useful to those skilled in the art can be used for plate 26. The small size and compact spacing of wells 34 make the precise alignment of wells 34 on a spotting or filling work station 20 difficult. In some embodiments plate 26 conforms to SBS/ANSI standard dimensions and is about 127 mm in length by about 85 mm in width. In some embodiments, plate 26 has at least 6,144 wells. While plate 26 is manufactured to precise dimensions, the level of flatness can deviate from the nominal value an extent that can lead to dispensed reagents and samples missing their targeted wells 34.

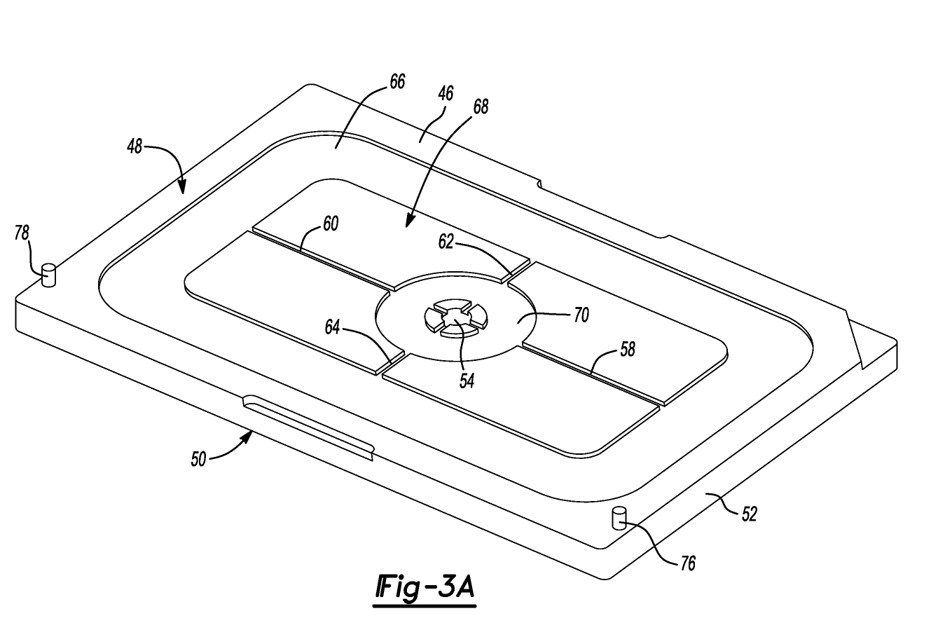

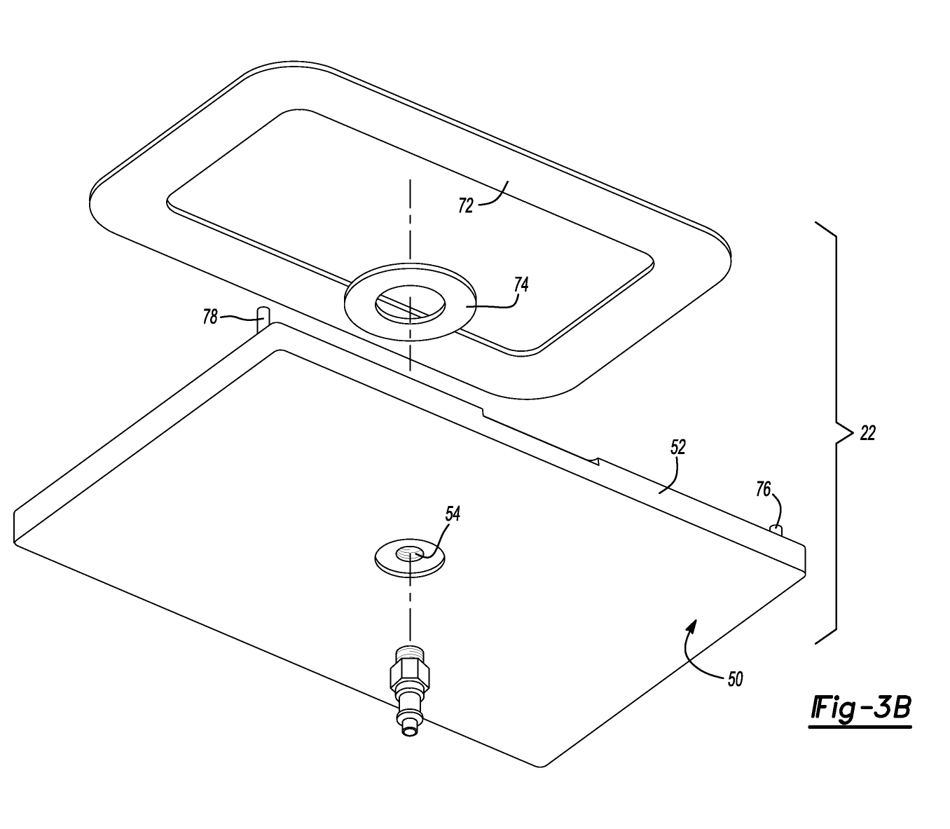

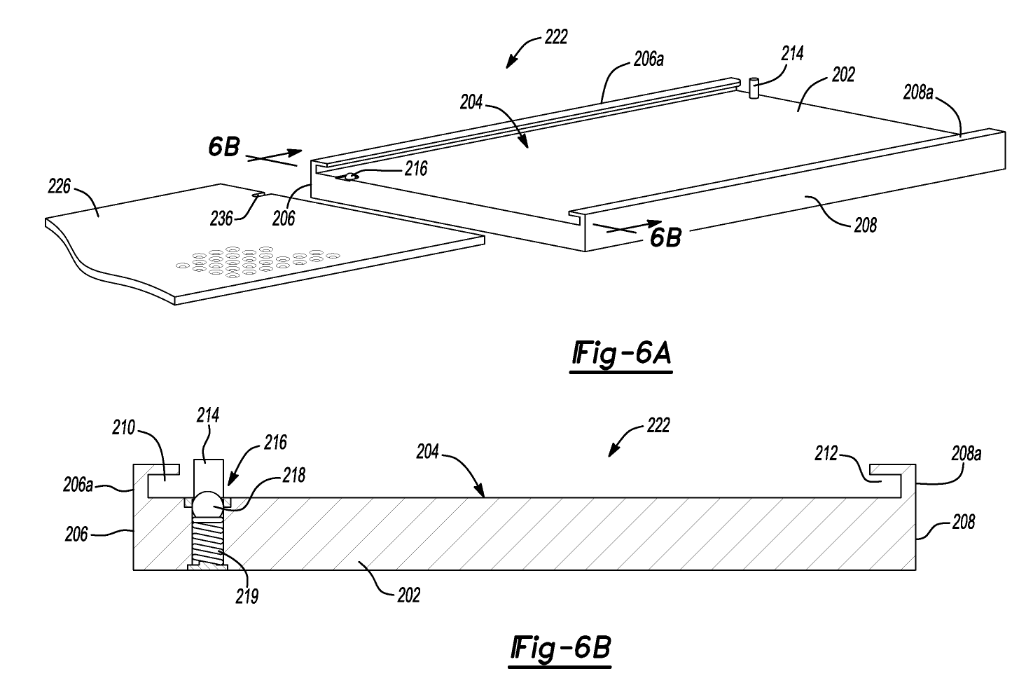

Flattening device 22 is operable to improve the flatness of plate 26 to a level that allows for precise alignment on spotting or filling work station 20 so that the reagents and samples can be accurately placed in the desired well. In the embodiments shown in FIGS. 2, 3A-B, 4 and 5A-D, a vacuum is applied to retain plate 26 to flattening device 22. The vacuum imparts a force on plate 26 that in conjunction with other aspects of flattening device 22 causes plate 26 to achieve a level of flatness equal to or better than a predetermined value, as described below. In the embodiments shown in FIGS. 6A-B and 7A-C the flattening device mechanically improves the flatness of plate 26 without the use of a vacuum, as described below.

Referring now to FIGS. 2 and 3A-B, details of one embodiment of flattening device 22 are shown. Flattening device 22 uses a rigid plate or chuck 46 having opposite first and second surfaces 48, 50 and a sidewall 52 therebetween. Chuck 46 is precisely dimensioned to allow indexing off a portion of sidewall 52 to align on an instrument deck 24 of a work station 20. If desired, chuck 46 may include alignment features that correspond with complementary alignment features on instrument deck 24 to align chuck 46 on instrument deck 24. In some embodiments, chuck 46 has a footprint about the size of a microtiter or microwell plate conforming to SBS/ANSI dimensional standards. In other embodiments, chuck 46 may have a footprint of a differing size. Chuck 46 is more rigid than plate 26 to allow chuck 46 to improve the flatness of plate 26. Chuck 46 can be made from a variety of materials. For example, chuck 46 can be made from steel, aluminum or other metals or materials, such as a polymer, as long as the rigidity of chuck 46 is greater than that of plate 26. For example, the beveled corner 39 on plate 26 may also be used as an alignment feature.

Chuck 46 includes a central aperture 54 which extends between first and second surfaces 48, 50. A vacuum fitting 56 can be attached to chuck 46 and extends from second surface 50. Fitting 56 communicates with aperture 54 to allow a vacuum source to be connected to chuck 46, as described below.

Two recessed fluid channels 58, 60 extend longitudinally along first surface 48 of chuck 46. Two other recessed channels 62, 64 extend laterally along first surface 48 of chuck 46. Fluid channels 58, 60, 62, 64 all communicate with aperture 54 to allow a vacuum to be pulled between plate 26 and first surface 48 of chuck 46 to retain plate 26 in place and improve the flatness, as described below.

As best seen in FIG. 3A, a first recessed retaining channel 66 in first surface 48 of chuck 46 circumscribes aperture 54 and extends adjacent sidewall 52. Retaining channel 66 defines a region 68 on first surface 48 of chuck 46 within which the vacuum is imparted to hold plate 26 on chuck 46 and improve the flatness, as described below. Fluid channels 58, 60, 62, 64 can terminate at or in retaining channel 66. A second recessed retaining channel 70 may be in first surface 48 of chuck 46 and circumscribe aperture 54 within region 68. Fluid channels 58, 60, 62 and 64 extend through retaining channel 70 as they extend toward retaining channel 66.

As best seen in FIGS. 2 and 3B, a sealing member 72 may be disposed in first retaining channel 66 and a support member 74 may be disposed in second retaining channel 70. Sealing member 72 and support member 74 protrude above first surface 48 of chuck 46. Sealing member 72 provides a vacuum-tight seal against second or bottom surface 30 of plate 26 and enables a vacuum to be maintained in region 68 to hold plate 26 to chuck 46 and improve the flatness. Sealing member 72 may be resilient and made from a variety of materials. For example, sealing member 72 may be an elastomer or other resilient material.

Support member 74 provides a support surface for the bottom or second surface 30 of plate 26. Support member 74 limits deformation of plate 26 due to the force of the vacuum between chuck 46 and plate 26. Support member 74 can be a stiff or rigid support or a resilient support that undergoes some deformation due to the force of the vacuum between plate 26 and chuck 46. As such, support member 74 can be a non-deformable gasket, O-ring or the like, or also function as a sealing member providing a fluid-tight seal between plate 26 and chuck 46 and made from an elastomer or other resilient material.

Fluid channels 58, 60, 62, 64 extend beneath support member 74 and allow a vacuum to be imparted to region 68 of chuck 46 both inside and outside of support member 74. Sealing member 72, support member 74 and first surface 48 of chuck 46 are dimensioned to provide a planar surface having a flatness equal to or better than a predetermined value when plate 26 is being held thereon by a vacuum. The vacuum may cause plate 26 to deform from its nominal shape and results in the predetermined level of flatness, or better, to be imparted to plate 26. The number of support members 74 and/or sealing members 72 can be increased or decreased to provide a required level of support to the bottom or second surface 30 of plate 26 to impart a desired level of flatness to plate 26. Furthermore, the width of sealing member 72 and/or support member 74 can be changed to provide a desired level of support to bottom surface 30 of plate 26. The predetermined level of flatness is chosen to allow precise positioning of plate 26 on chuck 46 and subsequently on instrument deck 24 to allow for accurate spotting and/or filling operations by work station 20. For example, a total flatness of equal to or better than 500 microns or a nominal value±250 microns or less can be the predetermined flatness level and imparted by chuck 46 to plate 26.

Chuck 46 may include alignment features to facilitate the alignment of plate 26 on chuck 46. In the embodiment shown in FIGS. 2, 3A-B and 4, the alignment features include two pins 76, 78 in the corners of first surface 48 of chuck 46. Pins 76, 78 extend from first surface 48 and respectively engage with slot 36 and aperture 38 on plate 26. Specifically, plate 26 is positioned on first surface 48 of chuck 46 with pin 78 extending into aperture 38. As plate 26 is moved into planar alignment with first surface 48, pin 78 engages with slot 36. The engagement of pins 76, 78 with slot 36 and aperture 38 align plate 26 precisely on chuck 46.

Instrument deck 24, as shown in FIG. 2, has an opening 82 through which fitting 56 on chuck 46 fits when chuck 46 is positioned on instrument deck 24. Fitting 56 on chuck 46 connects to a complementary fitting 84 that communicates with a vacuum source 86. Fittings 56, 84 can be of any known type that allows fluid communication therebetween. Fittings 56, 84 can be quick connect fittings that allow quick and easy connection and disconnection to/from vacuum source 86. Vacuum source 86 can be internal or external to work station 20. For example, a vacuum pump that is part of work station 20 can be used. The connection of vacuum source 86 to chuck 46 via fittings 56, 84 enables a vacuum to be formed in region 68 between first surface 48 of chuck 46 and bottom surface 30 of plate 26. When vacuum source 86 is activated, the vacuum will pull plate 26 against first surface 48, sealing member 72 and support member 74 and impart a flatness to plate 26 equal to or better than the predetermined value.

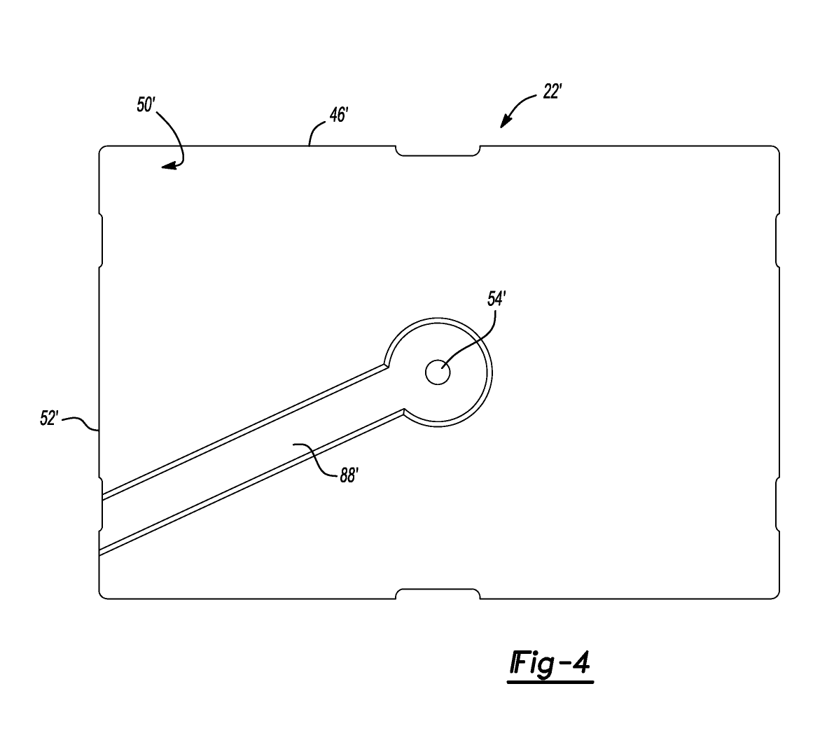

On instrument decks 24 without opening 82 therein the chuck will have a different arrangement to account for the lack of the opening in the instrument deck. Specifically, as shown in FIG. 4, a chuck 46′ can have a second surface 50′ with a recessed channel 88′. Channel 88′ extends from aperture 54′ to sidewall 52′. A recessed fitting (not shown) is attached to aperture 54′ and does not protrude beyond second surface 50′ of chuck 46′. A hose or conduit connected to a vacuum source can be routed through channel 88′ and connected to the recessed fitting in aperture 54′. In this manner, chuck 46′ can be positioned on a flat surface of an instrument deck and still be connected to a vacuum source to enable a vacuum to be imparted between a plate and the chuck to retain the plate thereon.

Referring now to FIGS. 5A-D, in some embodiments the flattening device 122 is integrated into the instrument deck and forms an integrated chuck/deck 192. In this case, the dimensions and shape of flattening device 122 will be dictated by the specific work station for which flattening device 122 is configured to be used with. Flattening device 122 uses a vacuum to retain plate 126.

As shown in FIG. 5C, support member 174 can take the form of a plurality of projections that extend upwardly from region 168 of integrated chuck/deck 192. Support members 174 can be arranged in a variety of patterns, as needed, to provide support for the bottom surface of plate 126 to prevent undesirable or unwanted deformation of plate 126 when subjected to the vacuum. Support members 174, in this embodiment, do not circumscribe aperture 154. With this configuration, fluid channels are not needed in integrated chuck/deck 192 to allow the vacuum to be imparted throughout region 168. Sealing member 172 circumscribes aperture 154 and provides a fluid-tight seal between plate 126 and integrated chuck/deck 192.

Integrated chuck/deck 192 can use the same alignment features discussed above with reference to FIGS. 2 and 3A-B or, as shown, can use a plurality of walls or projections 194 that extend outwardly from first surface 148 of integrated chuck/deck 192. As best seen in FIG. 5D, walls 194 include a tapered portion 196 and a vertical portion 198 that extend orthogonally from first surface 148 of integrated chuck/deck 192. Nubs 140 on plate 126 engage with tapered portions 196 and vertical portions 198 as plate 126 is positioned on integrated chuck/deck 192. The tapered portions 196 facilitate the placement of plate 126 on integrated chuck/deck 192 while vertical portions 198 provide precise alignment of plate 126 on integrated chuck/deck 192 via interaction with nubs 140.

In some embodiments according to the present teachings, flattening device 222 comprises a flattening block 202, as shown in FIGS. 6A and B. Flattening block 202 is configured to mechanically retain plate 226 and to impart a predetermined level of flatness or better to plate 226. Flattening block 202 is a rigid member having a rigidity greater than that of plate 226. Block 202 can be made from a variety of materials. For example, block 202 can be made from steel, aluminum or other metals or materials, such as a polymer, as long as the rigidity of block 202 is greater than that of plate 226. Block 202 is precisely dimensioned to allow indexing off a portion of the side wall to align on an instrument deck of a work station. If desired, block 202 can include alignment features that correspond with complementary alignment features on the instrument deck to align block 202 on the instrument deck. In this embodiment, block 202 may have a footprint the size of a microtiter plate conforming to SBS standards. In other embodiments, block 202 can have a footprint of a differing size. Flattening block 202 has a top surface 204 that has a flatness of the predetermined level of flatness or better. Top surface 204 supports bottom surface 230 of plate 226 when positioned on flattening block 202.

Opposing side extensions 206a, 208a of opposing sidewalls 206, 208 of flattening block 202 extend above top surface 204. Extensions 206a, 208a in conjunction with top surface 204 form opposing U-shaped channels 210, 212 that face one another. Channels 210, 212 are configured to receive sidewalls 232 of plate 226 therein. Specifically, channels 210, 212 have an internal vertical height that is dimensioned to be slightly larger than the nominal thickness of sidewalls 232 of plate 226. To attach plate 226 to flattening block 202, plate 226 is slid along top surface 204 with opposing sidewalls 232 disposed in channels 210, 212. The dimensions of channels 210, 212 cause plate 226 to have a level of flatness, at least in the direction parallel to the channels, to be equal to or better than the predetermined level of flatness.

Flattening block 202 can include alignment features to facilitate the alignment of plate 226 thereon. The alignment features can include channels 210, 212, an alignment pin 214 and a plunger mechanism 216. Channels 210, 212 guide plate 226 as it is slid along top surface 204 of flattening block 202. Pin 214 engages with slot 236 of plate 226 to limit the distance along top surface 204 that plate 226 can be slid. Plunger mechanism 216 comprises a ball 218 that nominally extends slightly above top surface 204 under the bias of a spring 219. Spring 219 allows ball 218 to be plunged into and retracted below top surface 204 when subjected to a force of an appropriate magnitude. When plate 226 is slid along top surface 204, bottom surface 230 of plate 226 pushes ball 218 below top surface 204. As slot 236 in plate 226 comes into full engagement with pin 214, ball 218 is aligned with aperture 238 in plate 226. Spring 219 causes ball 218 to extend upwardly and into engagement with aperture 238. Plunger mechanism 216 retains plate 226 in this orientation on top surface 204 of flattening block 202. To remove plate 226 from flattening block 202, a sliding force of a sufficient magnitude is imparted upon plate 226 to overcome the biasing of ball 218 by spring 219. Flattening block 202 thereby retains plate 226 thereon and imparts a level of flatness to plate 226 equal to or better than the predetermined level of flatness via the interaction with channels 210, 212 and top surface 204.

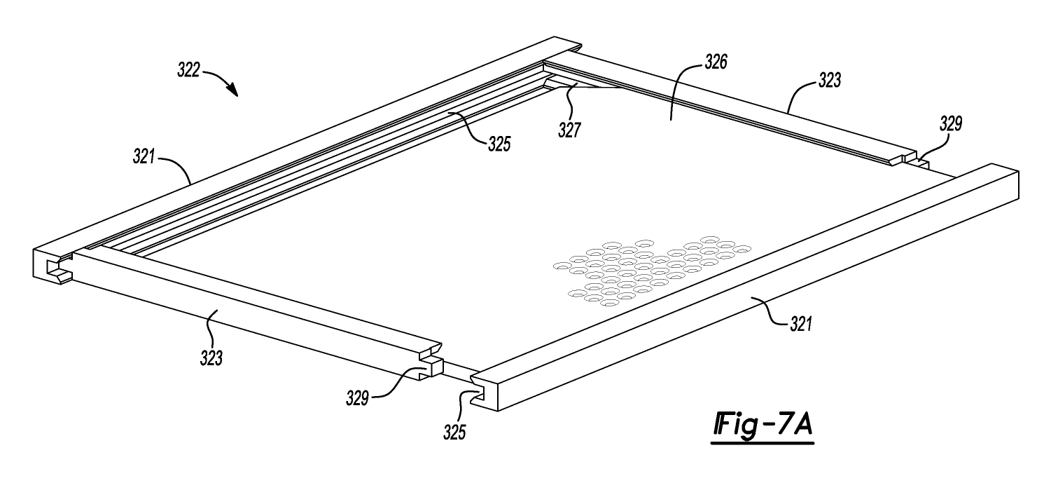

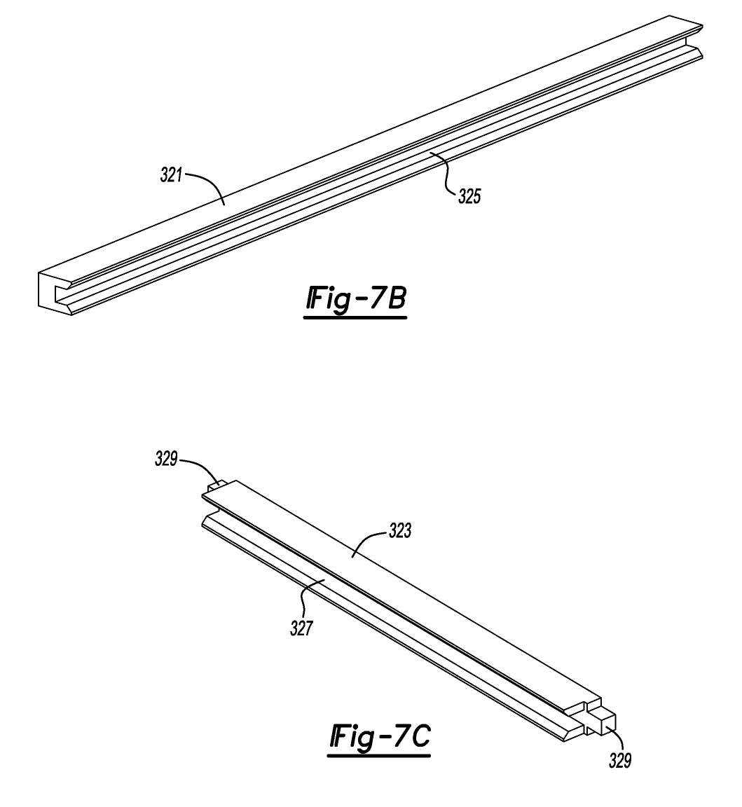

Other embodiments of flattening device 322, as shown in FIGS. 7A-C, use framing members to frame an entirety or a portion of plate 326 and impart a level of flatness that is equal to or better than a predetermined value. Flattening device 322 includes a pair of longitudinal framing members 321 and a pair of lateral framing members 323. Framing members 321, 323 have respective channels 325, 327 therein which are adapted to receive sidewalls 332 of plate 326. Channels 325, 327 are dimensioned to have an internal height that is slightly larger than a nominal thickness of sidewalls 332 of plate 326. The dimensions of channels 325, 327 cause plate 326 to have a level of flatness to be equal to or better than the predetermined level of flatness. Channels 325, 327 provide an interference fit with sidewalls 332 of plate 326. Lateral framing members 323 have end portions 329 that are dimensioned to fit within and provide an interference fit with channels 325 in longitudinal framing members 321. The interference fit allows lateral framing members 323 to be secured to longitudinal framing members 321. The interaction between sidewalls 332 of plate 326 and channels 325, 327 forces the sidewalls to conform to the straight and rigid nature of the channels and thereby impart a level flatness equal to or better than a predetermined value.

The framing members 321, 323 can be made from a variety of materials providing the framing members are more rigid than plate 326. For example, framing members 321, 323 can be made from steel, aluminum or other metals or from a polymer provided the rigidity is greater than that of plate 326. Framing members 321, 323 are made to precise dimensions and allow for indexing off an outer surface of one or more framing members 321, 323 to precisely position on an instrument deck. If desired, alignment features, such as pins and apertures or slots, can be employed on framing members 321, 323 and on the instrument deck to facilitate the aligning of plate 326 retained within framing members 321, 323 on an instrument deck within a work station.

Flattening device 322 can be used with less than two longitudinal framing members 321 and/or two lateral framing members 323. Specifically, any two framing members 321, 323 can be used in conjunction with one another to impart a level of flatness to plate 326 equal to or better than the predetermined value. For example, one longitudinal framing member 321 and one lateral framing member 323 can be used in conjunction with one another to form a generally “L-shaped” brace within which plate 326 is disposed.

While the present teachings are described in conjunction with various embodiments, it is not intended that the present teachings be limited to such embodiments. On the contrary, the present teachings encompass various alternatives, modifications, and equivalents, as will be appreciated by those of skill in the art. For example, the various features and components of the flattening devices disclosed herein can be mixed or interchanged with one another, as desired, to provide the associated benefits and/or advantages of using such features or components. Such variations are not to be regarded as a departure from the spirit and scope of the invention.

What is claimed is:

1. A system for imparting a predetermined level of flatness to a microwell plate, the system comprising:
a rigid member having opposite first and second surfaces;
an aperture on said first surface and extending through said rigid member, said aperture allowing a vacuum source to communicate with said first surface;
a sealing member engaging with and extending along said first surface, said sealing member having an opening therein circumscribing a region on said first surface within which said aperture resides, and said sealing member having an upper surface configured to engage with a bottom surface of a microwell plate; and
at least one support member on said first surface and within said region, said support member having an upper surface configured to engage with a bottom surface of a microwell plate,
wherein said upper surfaces of said sealing member and said at least one support member define a planar surface of a predetermined level of flatness that is imparted to a microwell plate engaged thereon and subjected to a vacuum in said region.

2. The system of claim 1, wherein said sealing member comprises a resilient sealing member.

3. The system of claim 1, further comprising a channel on said first surface surrounding said aperture and within which said sealing member resides.

4. The system of claim 1, wherein said support member comprises a second sealing member that extends along said first surface and surrounds said aperture and further comprising at least one channel in said first surface and within said region, said at least one channel extending from said aperture beyond and beneath said second sealing member and allowing fluid communication between said aperture and a space between said first and second sealing members.

5. The system of claim 4, wherein said at least one channel comprises a plurality of channels extending from said aperture beyond and beneath said second sealing member and allowing fluid communication between said aperture and a space between said first and second sealing members.

6. The system of claim 1, further comprising a channel in said second surface extending from said aperture to a side edge of said rigid member.

7. The system of claim 1, further comprising a fluid conducting fitting extending from said second surface and communicating with said aperture.

8. The system of claim 1, further comprising a vacuum source communicating with said region on said first surface and operable to impart a vacuum in said region between said first surface and the microwell plate.

9. The system of claim 1, further comprising at least one alignment feature on said rigid member, said at least one alignment feature comprising at least one pin projecting from said first surface of said rigid member.

10. The system of claim 1, further comprising at least one alignment feature on said rigid member, said at least one alignment feature comprising a plurality of walls extending outwardly from said first surface of said rigid member.

11. The system of claim 1, wherein said rigid member comprises a rigid member having a footprint that substantially conforms to SBS standards for a microtiter plate.

12. The system of claim 1, wherein said rigid member comprises an instrument deck for at least one of a spotting machine and a filling machine.

13. The system of claim 1, wherein at least a portion of said sealing member extends outwardly from said first surface.

14. The system of claim 1, wherein said rigid member comprises steel.

15. The system of claim 1, wherein said rigid member comprises aluminum.

16. The system of claim 1, wherein said rigid member comprises a rigid polymer.

17. The system of claim 1, wherein said region comprises a recessed portion of said rigid member.

18. The system of claim 1, wherein said at least one support surface comprises a portion of said rigid member.
